(19) United States
(12) Patent Application Publication
(10) Pub. No.: US 2021/0049924 A1
(43) Pub. Date: Feb. 18, 2021

(54) SIMULATOR

(71) Applicant: ROLLS-ROYCE plc, London (GB)

(72) Inventors: Peter A BEECROFT, Derby (GB); Andrew WALLACE, Southam (GB); Clive J. SOUTHERNWOOD, Bloxham (GB); Dominic HARGREAVES, Stratford-Upon-Avon (GB)

(73) Assignee: ROLLS-ROYCE plc, London (GB)

(21) Appl. No.: 16/929,310

(22) Filed: Jul. 15, 2020

(30) Foreign Application Priority Data
Aug. 15, 2019 (GB) 1911719.1

(51) Int. Cl. G09B 9/16; G09B 19/16; G06F 3/0488

(52) U.S. Cl. CPC G09B 9/165; G06F 3/0488; G09B 19/165

(57) ABSTRACT

A vehicle simulator including: a base; a plurality of moveable components; and one or more physical and/or power connectors for coupling the components to the base. The components are positionable on the base with the connectors coupling the components to the base in a first arrangement to simulate a first vehicle type. The components are moveable to and positionable on the base with the connectors coupling the components to the base in a second arrangement different to the first arrangement to simulate a second vehicle type.

### TECHNICAL FIELD

The present disclosure concerns a vehicle simulator, for example a flight simulator.

### BACKGROUND

Flight simulators are used to simulate the operation of an aircraft, for example operation in flight. Flight simulators are used for pilot training, or develop and test interfaces between pilots and aircrafts and/or for developing new aircraft concepts.

Flight simulators are designed to be representative of a particular type of aircraft. For example, flight simulators are limited to simulating either a wide body or a narrow body aircraft and are limited to simulating the type of aircraft from a single airframer.

### SUMMARY

The present disclosure seeks to provide a vehicle simulator, e.g. a flight simulator, that is modular in nature such that it can be configured to represent a large number of different vehicles, e.g. aircraft.

According to an aspect there is provided a vehicle simulator comprising a base, a plurality of moveable components, and one or more physical and/or power connectors for coupling the components to the base. The components are positionable on the base with the connectors coupling the components to the base in a first arrangement to simulate a first vehicle type, and the components are moveable to and positionable on the base with the connectors coupling the components to the base in a second arrangement different to the first arrangement to simulate a second vehicle type.

The simulator components may be one or more of a display screen, a touchscreen, a device shaped as a physical controller with an integrated touchscreen, a control stick, a lever, a yoke, a seat, a foot pedal and a console.

The physical connectors for physically coupling the components to the base may be provided as a multi-part connector, with one part of the connector provided on the base and one part of the connector provided on the component, for example, the part of the connector on the component may physically engage with the part of the connector on the base when the component is coupled to the base.

One or more of the connectors may be a physical power and data connector. One part of the connector may be provided on the base and another part of the connector may be provided on the component.

One or more of the connectors may comprise an inductive device carried by the component and an inductive array carried by the base.

The component may further comprise a wireless transmitter and/or receiver.

The component may comprise a battery.

The one or more connectors may comprise a physical connector and the base may comprise a recess to receive the component.

The base may comprise a fixed display screen. At least one of the components may be a moveable display screen and/or a touch screen. One or more of the connectors may be a physical connector that connects the moveable display screen and/or touchscreen to one side of the fixed display screen.

The connector may comprise a plurality of fasteners for fastening the fixed display screen to the moveable display screen and/or touch screen.

The fixed display screen may be a touch screen.

The base may define a platform and a column extending from the platform. The fixed display may be connected to the column, e.g. the fixed display may be provided in a housing which is connected to the column.

The moveable display screen and/or touchscreen may be provided with electrical and/or data connections via the fixed display screen.

The fixed display screen and the moveable display screen and/or touch screen and one or more of the connectors may be configured such that when connected together the display screen and moveable display screen and/or touch screen form a contiguous screen.

The moveable display screen and/or touch screen may be housed in a housing. The housing may have sufficient rigidity to enable cantilever mounting of the moveable display screen and/or touch screen.

The skilled person would understand that sufficient rigidity to enable cantilever mounting means that the assembly of display and/or touch screens is a stable structure that can be used on a flight deck. In embodiments where components are connected to the display and/or touch screens or housings thereof, the rigidity of the housings is such that movement of the housings and display and/or touch screens is limited to a degree such that any movement is undetected or barely detected by a user.

One or more of the components may be a seat. The base may comprise rails for receiving the seat. The rails may be configured to adjust the seating position of the pilot relative to other components of the flight simulator.

The base may comprise a plurality of rails arranged such that either one seat or two seats can be connected to the base.

For example, the base may comprise 6 rails arranged in pairs so as to define three seat positions. The seat positions may be arranged to simulate an aircraft with one pilot seat or an aircraft with two pilot seats.

Alternatively, the seat may comprise rails arranged such that the seat is adjustable relative to other components of the flight simulator.

The simulator may comprise a window shroud (e.g. fixed or removable) that at least partially encloses the components of a simulator, e.g. to simulate a fuselage of an aircraft.

The simulator may comprise a removable shroud that at least partially encloses the components of the flight simulator.

The base may comprise one or more physical connector ports for receiving a larger shroud and one or more physical connector ports for receiving a smaller shroud.

The simulator may comprise a control system. The control system may comprise a processor, memory and computer readable software. The software may be arranged in modules, each module being separable from the other modules and each module simulating a different feature of flight or an aircraft.

The modules may comprise a functional mock up interface (FMI).

One of the components may be a side console and side stick and the side console may be received in a recess provided on the base.

The flight simulator may comprise one or more display screens and/or touchscreens mounted in a housing and the one of the components may be a yoke, and the yoke may be connected via a physical connector to the housing.

For example the yoke may be connected to the fixed display screen or to one of the moveable display and/or touch screens.

Alternatively, the yoke may be connected via a mounting arrangement to the side console.

The simulator may be a flight simulator.

According to an aspect there is provided a vehicle simulator comprising a base, and a plurality of components detachably connected to the base so as to permit reconfiguration of the vehicle simulator such that the plurality of components can be detached from the base, arranged in an alternative configuration and reattached to the base. One or more of the components are one or more of a display screen, a touchscreen, a device shaped as a physical controller with an integrated touchscreen, a control stick, a lever, a yoke, a seat and a window screen.

The simulator may be a flight simulator.

The skilled person will appreciate that except where mutually exclusive, a feature described in relation to any one of the above aspects may be applied mutatis mutandis to any other aspect. Furthermore except where mutually exclusive any feature described herein may be applied to any aspect and/or combined with any other feature described herein.

### DESCRIPTION OF THE DRAWINGS

Embodiments will now be described by way of example only, with reference to the Figures, in which:

FIG. 1 is a perspective view of a simulator;

FIG. 2 is a schematic plan view of a simulator with interfaces provided in the base for receiving components;

FIGS. 3 to 5 are example connections between components and a base of the simulator;

FIG. 6 is a schematic plan view of a configuration of the simulator of FIG. 1;

FIG. 7 is an alternative schematic plan view of a configuration of the simulator of FIG. 1;

FIG. 8 is a further alternative schematic plan view of a configuration of the simulator of FIG. 1;

FIG. 9 is a yet further alternative schematic plan view of a configuration of the simulator of FIG. 1;

FIG. 10 is a block diagram of the control arrangement of the flight simulator of FIG. 1; and

FIG. 11 is a block diagram showing the configuration of software modules of the flight simulator of FIG. 1.

### DETAILED DESCRIPTION

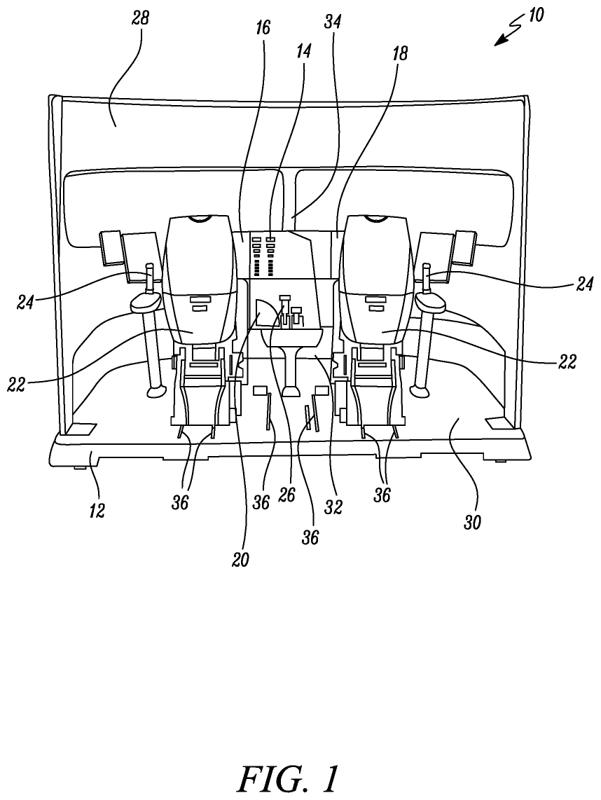

Referring to FIG. 1, a flight simulator 10 simulates the flight deck (also known as cockpit) of an aircraft. The simulator generally includes screens 14, 16, 18, 20 to display information related to a simulated flight and a simulated aircraft, seats 22 for the pilots, and physical or simulated controls 24, 26 used by pilots during flights. A shroud 28 (which may be referred to as a window shroud) curves around the screens, seat and controls to imitate the fuselage of an aircraft. The shroud 28 may include a window or screen to imitate the window of an aircraft.

In the present example, the flight simulator 10 includes a base unit 12 to which components can be connected to simulate a given aircraft. The components can be moved to an alternative position to simulate an alternative aircraft type. In this example, the components include the screens 16, 18, 20, the seats 22, and the controls 24, 26. In addition it is possible to detach the window shroud 28 and replace it with an alternative window shroud to better simulate a given aircraft. The features of the base and components are described in more detail below.

The base 12 of the simulator includes a platform 30 which provides a floor for a user to walk and a surface for components to connect to. The base further includes a column 32 projecting upwardly from the platform. In the present example the column projects upwardly and in a direction towards the seats 22. In the present example, the base further comprises a housing 34 which houses a screen 14. The housing 34 and optionally the screen 14 are permanently mounted to the column 32.

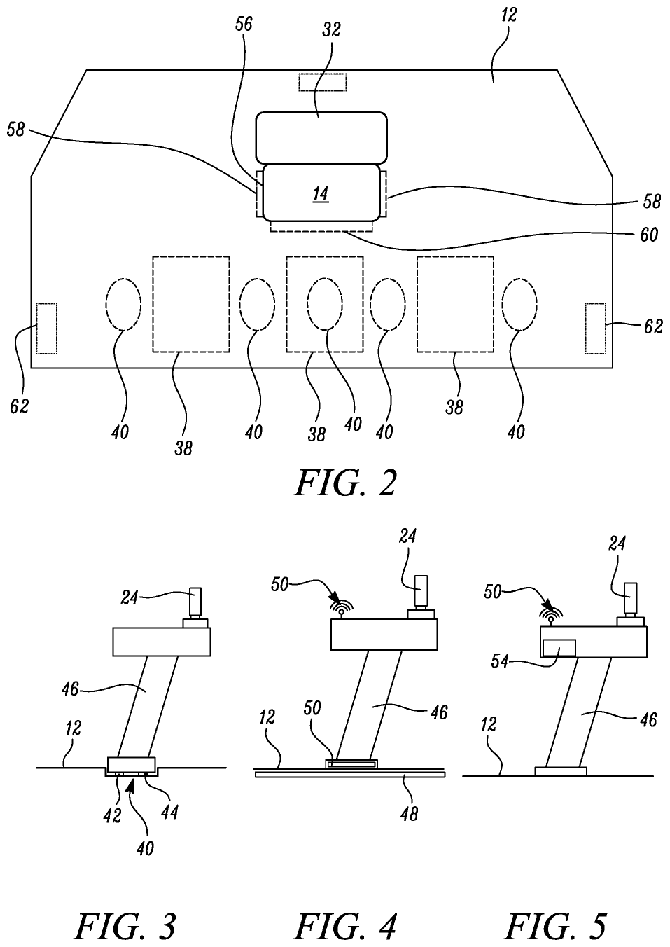

The base includes connectors or part of connectors for attachment of the components to the base. An example connector are rails 36. In the present example, rails 36 are provided in pairs, each pair connecting to a seat. Three pairs of rails are provided so as to define three seat locations: one central seat location, and two side seat locations. The seat locations are illustrated at 38 in FIG. 2. In the present example, the seats 22 are provided with couplings that locate in the rails of the tracks. The couplings can engage with the tracks at multiple locations so as to adjust the position of the seat. The couplings of the seat may be arranged such that the seat can be adjusted to discrete positions on the rails or may be arranged to permit attachment at any desired position. The couplings of the seat and the rails may together be considered a connector, such that in this example part of the connector is provided on the seat and another part of the connector is provided on the base.

Referring now to FIGS. 2 and 3, the base 12 includes interfaces 40 for locating components on the base. In some examples, the interfaces may comprise a recess for receiving components. For example, the interfaces may receive a console 46 which may include control 24. The control 24 may be provided in the form of a control stick. The interface includes one part of power and data connectors 42, 44 and the consoles 46 include the other part of the power and data connectors. The power connector supplies power to the devices provided on the console, for example the control stick, and the data connection permits data to be communicated between the devices and a remainder of a control system of the flight simulator.

Referring to FIG. 4, in an alternative embodiment, the base may be provided with an inductive array 48, for example under the platform on which users can walk. In such an example, the consoles include an inductive device 50. The inductive array and inductive device are an example of a power connector because the devices interact to provide power to the devices (or components) provided on the console. In such examples, the consoles may be provided with a wireless transmitter and/or receiver 52, in this way a need for a physical data connection between the component (in this case the console and control) and the base is eliminated. The provision of an inductive array and inductive device provides increased flexibility in relation to where the components are to be positioned. Referring to FIG. 5, in a further alternative embodiment the console may comprise a battery 54 and a wireless transmitter and/or receiver 52 so as to also eliminate the need for a physical power connection.

In some examples, it may not be necessary to secure the console 46 to the base 12, but in some examples it may be advantageous to do so and in such examples one or more fasteners may be used to secure the console to the base, for example: bolts, screws, magnets, clips, or any other suitable fastener may be used.

The example has been described with reference to console 46 which carries control 24, but similar arrangements can be used to secure other consoles to the base, for example the console that carries the throttle lever (often referred to as throttle).

Referring back to FIGS. 1 and 2, as mentioned previously, the base includes the column 32 to which a screen 14 is connected. In the present example, the screen is provided in the housing 56. In the present example, the housing 56 is fixedly connected to the column 32 such that the screen 14 is immovably connected to the column (apart from being removable for maintenance). In this way the housing 56 and screen 14 may also be considered to form part of the base, since these components are always provided in the same position regardless of the configuration of the flight simulator (i.e. regardless of the position of the other components of the flight simulator and/or the type of aircraft being simulated). Power and data connections are provided to the screen 14 via the column 32. The column 32 and screen 14 may be provided in a laterally central position on the flight simulator.

Connectors 58, 60 are provided on the side (or edge) of the housing 56 to connect components such as additional screens 16, 18, 20 to the housing 56. The connectors may be for example clips, bolts, screws, brackets and/or any other suitable fastener. The additional screens 16, 18, 20 each may optionally be provided in a housing to ease connection of the screens to the housing 56. The screens 14, 16, 18, 20 and connectors 58, 60 may be arranged such that the screens appear to be a single contiguous display. Additional screens may be connected to the screens 16, 18, 20 or the housing of said screens so that the size of the display area can be adapted to simulate a specific type of aircraft, for example to simulate a wide body or a narrow body aircraft. In a similar way to that described for the housing 56, connectors may be provided to connect one screen or housing of one screen to an adjacent screen or an adjacent housing of a screen. The housing may be rigid and the housings and connectors may be arranged so that the screens are cantilevered from the column 32. The rigid construction of the housings is such that the screens do not flex or only flex by a degree that does not impede the operation of the flight simulator, for example the housings and connectors may have a construction and arrangement such that when a user applies a load to one or more of the housings during normal operation of the flight simulator the user does not perceive movement of the display.

Power and data connections for the screens 16, 18, 20 are provided via the screen 14.

Additional components of the flight simulator may be connected to the screens 14, 16, 18 and/or 20. For example, a yoke (also known as control wheel) may be mounted via a bracket to a connector or to the housing of one of the screens.

The screens 14, 16, 18, 20 may be display screens and/or touch screens, e.g. they may display information to a user and the screen may also be a user input device. Physical devices may also be provided to provide an input to the flight simulator, in such examples the physical devices may carry touch screen interfaces, but in alternative embodiments, replicas of the physical devices of an aircraft may be provided. The physical devices may be connected to the screens or housings of the screens. Providing replica physical devices or physical devices with touch screen interfaces may in some examples better represent the controls of a given aircraft.

As mentioned previously, a shroud 28 is provided to simulate the fuselage of an aircraft. The base 12 includes connectors to secure the shroud in position. In the present example, the base includes a recess 62 at both lateral sides of the flight simulator. The shroud includes a portion that is received in the recess 62. The shroud is then secured in position using a suitable fastener, e.g. bolt, screws, clips, magnets, etc.

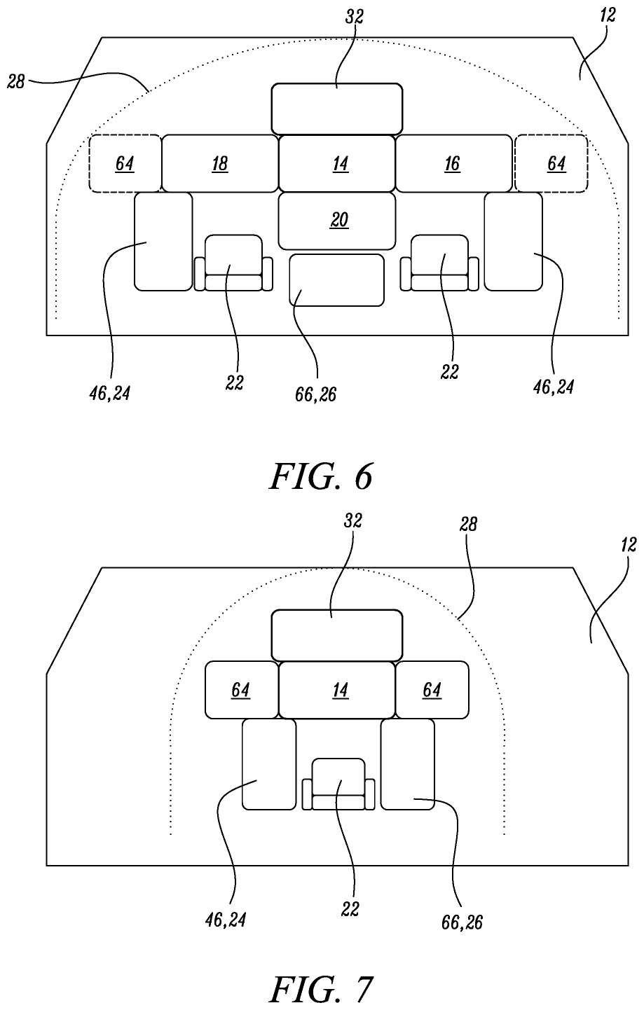

Various optional configurations of the flight simulator will now be described with reference to FIGS. 6 to 9.

Referring to FIG. 6, an example arrangement with two pilots is shown. This may be for example simulating a wide body aircraft. As in all examples, the base 12 includes a column 32 to which the screen 14 is mounted (the screen 14 is often mounted in a housing). Two seats 22 are connected to the rails of the base and a console 66, with the throttle 26, is provided between the seats 22. As described previously the console may be received at an interface of the base 12. Side consoles 46 are provided either side of the seats 22, and carry controls 24 in the form of side sticks. A screen 20 may be mounted to an underside of a central screen 14, and screens 16 and 18 may be mounted to the lateral sides of the screen 14. In addition, additional screens or tablets 64 may be mounted to the sides (e.g. the lateral sides) of the screens 16 and 18. The screens 14, 16, 18 and 20 create a contiguous display. In the present example the screens 64 do not form part of the contiguous display but in alternative embodiments the screens 64 may also form part of the contiguous display. The shroud 28 extends around the sides of the seats and the rear of the screens 14, 16, 18 and 64.

Referring to FIG. 7, an example arrangement with only a single pilot is shown. The example of FIG. 7 may be simulating a single seat aircraft such as a military fast jet. As in all examples, the base 12 includes a column 32 to which the screen 14 is mounted (the screen 14 is often mounted in a housing). A single seat 22 is provided and is connected to the rails of the base that are provided central to the base. A side console 46 with a side stick 24 is provided at one side of the seat 22 and a throttle console 66 with a throttle 26 is provided at the other side of the seat. In this example, only one screen or tablet 64 is connected to either side of the screen 14. A shroud 28 is provided on each side of the seat and around the back of the screens 14, 64. As can be seen by comparing FIGS. 6 and 7, the shroud of the present example is smaller than the shroud of the previous example so as to better simulate a narrow bodied aircraft.

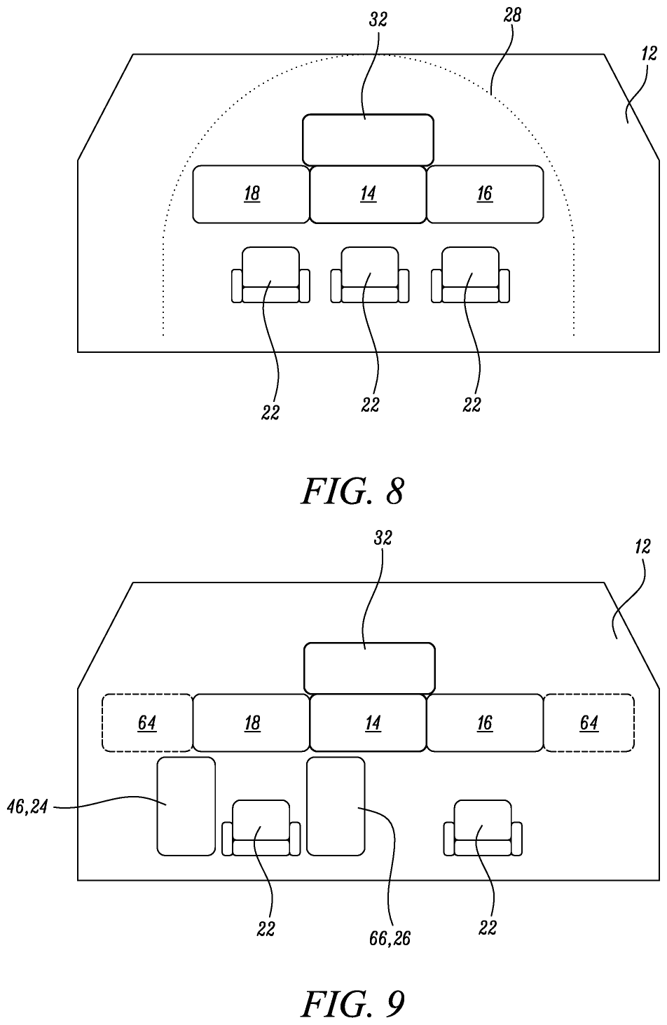

Referring to FIG. 8, an example arrangement with three users is shown, such as might be present in an autonomous air taxi. As in all examples, the base 12 includes a column 32 to which the screen 14 is mounted (the screen 14 is often mounted in a housing). In this example three seats 22 are provided, each seat engaging with one of the pairs of rails provided on the base 12. Two screens 16, 18 are provided and connected to the lateral sides of screen 14. One or more of the screens 14, 16, 18 may be touch screens to provide user inputs to the flight simulator, or alternatively devices may be attached to the screens and the devices may have touchscreen interfaces. A window shroud 28 is connected to the base and extends around the sides of the seats and the back of the screens 14, 16, 18.

Referring to FIG. 9, an example of an arrangement with a remote pilot and user station is shown. In this case no window shroud is provided because the pilot is remote. As in all examples, the base 12 includes a column 32 to which the screen 14 is mounted (the screen 14 is often mounted in a housing). Two seats are provided and connected to the rails of the base. To the side of one of the seats a side console 46 with a side stick 24 is provided and to the other side of the same seat a throttle console 66 and throttle 26 is provided. No controls are provided at the sides of the other seat. Screens 16 and 18 are connected to the screen 14 to create a contiguous display and additional screens 64 (which may be screens of tablet computers) are connected to the screens 16 and 18.

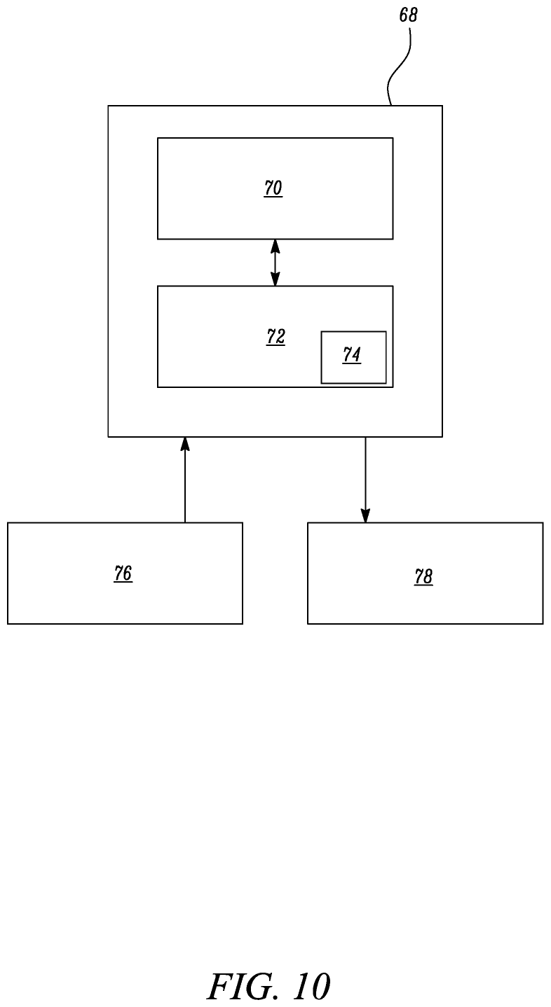

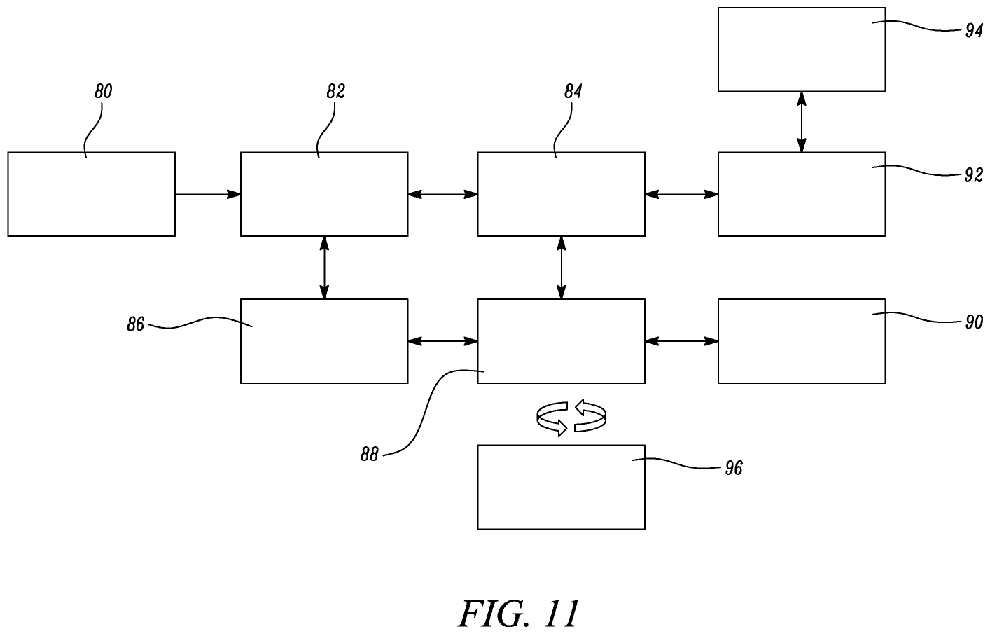

FIG. 10 illustrates a schematic diagram of a control arrangement of the flight simulator according to various examples. The control arrangement includes a controller 68, a user input device 76, and an output device 78. In some examples, the control arrangement may be modular. For example, different elements of the control arrangement can be removed and added by a user.

The user input device 76 may comprise any suitable device for enabling an operator to at least partially control the apparatus. In addition to the previously described input devices of touchscreens (e.g. touchscreens of screens 14, 16, 18, 20 and/or 64), control stick 24, throttle lever 26 and optionally the yoke, the user input device may also comprise one or more of a keyboard, a keypad, a touchpad, a computer mouse, an additional control stick, throttle lever, and/or a device shaped as a physical controller but mounted to a touchscreen to act as an interface. The controller is configured to receive signals from the user input device.

The output device 78 will most commonly be one or more of screens 14, 16, 18, 20, 64 but may be any suitable device for conveying information to a user. For example, the output device may be a display (such as a liquid crystal display, or a light emitting diode display, or an active matrix organic light emitting diode display, or a thin film transistor display, or a cathode ray tube display), and/or a loudspeaker, and/or a printer (such as an inkjet printer or a laser printer) and/or physical stimulus generator such as vibration device. The controller is arranged to provide a signal to the output device to cause the output device to convey information to the user.

The controller 68, the user input device 76, and the output device 78 may be coupled to one another via a wireless link and may consequently comprise transceiver circuitry and one or more antennas. Additionally or alternatively, the controller, the user input device and the output device may be coupled to one another via a wired link and may consequently comprise interface circuitry (such as a Universal Serial Bus (USB) socket). It should be appreciated that the controller, the user input device, and the output device may be coupled to one another via any combination of wired and wireless links.

The controller 68 may comprise: control circuitry; and/or processor circuitry; and/or at least one application specific integrated circuit (ASIC); and/or at least one field programmable gate array (FPGA); and/or single or multi-processor architectures; and/or sequential/parallel architectures; and/or at least one programmable logic controllers (PLCs); and/or at least one microprocessor; and/or at least one microcontroller; and/or a central processing unit (CPU); and/or a graphics processing unit (GPU), to perform the methods.

In various examples, the controller may comprise at least one processor 70 and at least one memory 72. The memory stores a computer program 74. The computer program may be software or firmware, or may be a combination of software and firmware.

The processor 70 may include at least one microprocessor and may comprise a single core processor, may comprise multiple processor cores (such as a dual core processor or a quad core processor), or may comprise a plurality of processors (at least one of which may comprise multiple processor cores).

The memory 72 may be any suitable non-transitory computer readable storage medium, data storage device or devices, and may comprise a hard disk and/or solid state memory (such as flash memory). The memory may be permanent non-removable memory, or may be removable memory (such as a universal serial bus (USB) flash drive or a secure digital card). The memory may include: local memory employed during actual execution of the computer program; bulk storage; and cache memories which provide temporary storage of at least some computer readable or computer usable program code to reduce the number of times code may be retrieved from bulk storage during execution of the code.

The computer program 74 may be stored on a non-transitory computer readable storage medium. The computer program may be transferred from the non-transitory computer readable storage medium to the memory. The non-transitory computer readable storage medium may be, for example, a USB flash drive, a secure digital (SD) card, an optical disc (such as a compact disc (CD), a digital versatile disc (DVD) or a Blu-ray disc). In some examples, the computer program may be transferred to the memory via a wireless signal or via a wired signal.

Input/output devices 76, 78 may be coupled to the system either directly or through intervening input/output controllers. Various communication adaptors may also be coupled to the controller to enable the apparatus to become coupled to other apparatus or remote printers or storage devices through intervening private or public networks. Non-limiting examples include modems and network adaptors of such communication adaptors.

The computer program 74 is modular in nature. For example, the computer program may be provided as modules with functional mock-up interfaces (FMI). FIG. 10 illustrates an example of the modules that may be provided as part of the computer program. These modules include: environment 80, aircraft flight dynamics 82, aircraft systems 84, powerplant dynamics 86, powerplant systems 88, engine OEM ground support systems 90, flight deck 92, and airspace control 94. It is possible with the modular arrangement of the computer program to swap one of the computer program modules with hardware 96 whilst maintaining the same interfaces between the modules of the computer program.

The described flight simulator means that different aircraft can be easily simulated without the cost of building multiple simulators. This is particularly useful for simulators used for the development of aerospace technology.

In the described embodiments, touchscreens (e.g. on displays and/or on physical devices) permit a wide range of controls to be easily represented. The provision of removable components such as seats, screens, consoles, controls and the shroud, and data and power connections where necessary to said components permits ease of configuration to a desired aircraft type. Modular software with generic interfaces between modules, e.g. using a formal interface standard, eases the configuration of a desired aircraft and ensures compatibility between models implementing various different software tools.

The simulator has been described in relation to a flight simulator, but in alternative embodiments the simulator could be used for non-aerospace applications, for example ground or marine vehicles.

In some examples virtual and/or augmented reality may be used with the described simulator to enhance visual stimulus to the pilots.

It will be understood that the invention is not limited to the embodiments above-described and various modifications and improvements can be made without departing from the concepts described herein. For example, a different number of seats or screens and associated connectors may be provided to the number described.

Except where mutually exclusive, any of the features may be employed separately or in combination with any other features and the disclosure extends to and includes all combinations and sub-combinations of one or more features described herein.

1. A vehicle simulator comprising:
a base;
a plurality of moveable components; and
one or more physical and/or power connectors for coupling the components to the base;
wherein the components are positionable on the base with the connectors coupling the components to the base in a first arrangement to simulate a first vehicle type, and the components are moveable to and positionable on the base with the connectors coupling the components to the base in a second arrangement different to the first arrangement to simulate a second vehicle type, and
wherein the base comprises a fixed display screen, and wherein at least one of the components is a moveable display screen and/or a touch screen, and wherein one or more of the connectors is a physical connector that connects the moveable display screen and/or touchscreen to one side of the fixed display screen.

2. The vehicle simulator according to claim 1, wherein the components are one or more of a display screen, a touchscreen, a device shaped as a physical controller with an integrated touchscreen, a control stick, a lever, a yoke, a seat and a console.

3. The vehicle simulator according to claim 1, wherein one or more of the connectors are a physical power and data connector, with one part of the connector being provided on the base and another part of the connector being provided on the component.

4. The vehicle simulator according to claim 1, wherein one or more of the connectors comprise an inductive device carried by the component and an inductive array carried by the base.

5. The vehicle simulator according to claim 3, wherein the component further comprises a wireless transmitter and/or receiver.

6. The vehicle simulator according to claim 1, wherein the one or more connectors comprises a physical connector and the base comprises a recess to receive the component.

7. The vehicle simulator according to claim 1, wherein the fixed display screen and the moveable display screen and/or touch screen and one or more of the connectors is configured such that when connected together the display screen and moveable display screen and/or touch screen form a contiguous screen.

8. The vehicle simulator according to claim 1, wherein the moveable display screen and/or touch screen is housed in a housing, the housing having sufficient rigidity to enable cantilever mounting of the moveable display screen and/or touch screen.

9. The vehicle simulator according to claim 1, wherein one or more of the components is a seat, and wherein the base comprises rails for receiving the seat, the rails being configured to adjust the seating position of the pilot relative to other components of the flight simulator.

10. The vehicle simulator according to claim 9, wherein the base comprises a plurality of rails arranged such that either one seat or two seats can be connected to the base.

11. The vehicle simulator according to claim 1, further comprising a removable shroud that at least partially encloses the components of the flight simulator.

12. The vehicle simulator according to claim 11, wherein the base comprises one or more physical connector ports for receiving a larger shroud and one or more physical connector ports for receiving a smaller shroud.

13. The vehicle simulator according to claim 1 comprising a control system, the control system comprising a processor, memory and computer readable software, wherein the software is arranged in modules, each module being separable from the other modules and each module simulating a different feature of flight or an aircraft.

14. The vehicle simulator according to claim 1, wherein one of the components is a side console and side stick and the side console is received in a recess provided on the base.

15. The vehicle simulator according claim 1, wherein the flight simulator comprises one or more display screens and/or touchscreens mounted in a housing and the one of the components is a yoke, and the yoke is connected via a physical connector to the housing.

16. A vehicle simulator comprising:
a base; and
a plurality of components detachably connected to the base so as to permit reconfiguration of the vehicle simulator such that the plurality of components can be detached from the base, arranged in an alternative configuration and reattached to the base;
wherein one or more of the components are one or more of a display screen, a touchscreen, a device shaped as a physical controller with an integrated touchscreen, a control stick, a lever, a yoke, a seat and a window screen; and
wherein the base comprises a fixed display screen, and wherein at least one of the components is a moveable display screen and/or a touch screen, and wherein one or more of the connectors is a physical connector that connects the moveable display screen and/or touchscreen to one side of the fixed display screen.

17. The vehicle simulator according to claim 1, wherein the simulator is a flight simulator.

18. A vehicle simulator comprising:
a base;
a plurality of moveable components; and
one or more physical and/or power connectors for coupling the components to the base;
wherein the components are positionable on the base with the connectors coupling the components to the base in a first arrangement to simulate a first vehicle type, and the components are moveable to and positionable on the base with the connectors coupling the components to the base in a second arrangement different to the first arrangement to simulate a second vehicle type, and
wherein one or more of the connectors comprise an inductive device carried by the component and an inductive array carried by the base.

19. The vehicle simulator according to claim 18, wherein the component further comprises a wireless transmitter and/or receiver.
